(19) United States
(12) Patent Application Publication
(10) Pub. No.: US 2013/0182899 A1
(43) Pub. Date: Jul. 18, 2013

(54) INFORMATION PROCESSING APPARATUS, STORE SYSTEM AND METHOD

(71) Applicant: Toshiba Tec Kabushiki Kaisha, Tokyo (JP)

(72) Inventors: Hidehiro Naito, Shizuoka-ken (JP); Hiroshi Sugasawa, Miyagi-ken (JP); Hitoshi Iizaka, Shizuoka-ken (JP)

(73) Assignee: TOSHIBA TEC KABUSHIKI KAISHA, Tokyo (JP)

(21) Appl. No.: 13/737,105

(22) Filed: Jan. 9, 2013

(30) Foreign Application Priority Data
Jan. 16, 2012 (JP) 2012-006435

(51) Int. Cl. G06K 9/62

(52) U.S. Cl. CPC G06K 9/6201
USPC 382/103

(57) ABSTRACT

An information processing apparatus comprises a similarity calculation unit calculates a similarity showing the degree of similarity between the image of an object captured and the reference image of each registered commodity, which is registered together with a superior category showing information relevant with each registered commodity registered in a dictionary, a determination unit compares the degree of similarity between the reference image and each image acquired by an acquisition unit and determines whether or not the degree of similarity of the superior category acquired by adding the similarities of a plurality of varieties belonging to the same superior category meets a specified condition and a reporting unit reports the information relevant with a commodity corresponding to the plurality of varieties meeting the specified condition as a candidate of a captured commodity in the situation that the determination unit determines that the specified condition is met.

### CROSS-REFERENCE TO RELATED APPLICATION

This application is based upon and claims the benefit of priority from Japanese Patent Application No. 2012-006435, filed Jan. 16, 2012, the entire contents of which are incorporated herein by reference.

### FIELD

Embodiments described herein relate to an information processing apparatus, a store system and a method.

### BACKGROUND

Formerly, the following technology, relevant with a generic object recognition, that the characteristic quantity of a target article is extracted from image data obtained by capturing the target article (object) by an image sensor, the characteristic quantity is compared with check data (characteristic quantity) previously prepared in a dictionary to calculate a similarity, and the category of the article and the like is recognized (detected) according to the calculated similarity is known. In addition, a store system which used the technology relevant with the generic object recognition for the recognition of a commodity such as a fruit, a vegetable and the like to carry out sales registration on the recognized commodity is provided.

### BRIEF DESCRIPTION OF THE DRAWINGS

FIG. 1 is a perspective view showing an example of a checkout system according to an embodiment;

FIG. 2 is a block diagram showing hardware components of a POS terminal and a commodity reading apparatus;

FIG. 3 is a conceptual diagram illustrating an example of a data construction of a PLU file;

FIG. 4 is a block diagram showing functional components of the POS terminal and the commodity reading apparatus;

FIG. 5 is a view showing an example of a frame image;

FIG. 6 is a view showing an example of a determination screen;

FIG. 7 is a view showing an example of a confirmation screen;

FIG. 8 is a view showing an example of a screen displaying an illustration image of a candidate commodity;

FIG. 9 is a view showing an example of a category selection screen of the candidate commodity;

FIG. 10 is a flow chart showing the procedures of a commodity recognition processing;

FIG. 11 is a flow chart showing the procedures of a sales registration processing;

FIG. 12 is an external perspective view showing compositions of a self-checkout POS system; and

FIG. 13 is a block diagram showing hardware components of the self-checkout POS system.

### DETAILED DESCRIPTION

In accordance with one embodiment, an information processing apparatus includes an image capturing unit configured to capture a commodity to output the image of the commodity, an image acquisition unit configured to acquire the image outputted by the image capturing unit, a similarity calculation unit configured to calculate a similarity showing the degree of similarity between the image of the commodity captured by the image capturing unit and the reference image of each registered commodity, which is registered together with a superior category showing information relevant with each registered commodity in a dictionary, a determination unit configured to compare the degree of similarity between the reference image and each image acquired by the image acquisition unit and determine whether or not the degree of similarity of the superior category obtained by adding the similarities of a plurality of varieties belonging to the same superior category meets a specified condition and a reporting unit configured to report the information relevant with a commodity corresponding to the plurality of varieties meeting the specified condition as a candidate of the captured commodity if the determination unit determines that the specified condition is met.

An information processing apparatus, a store system and a program according to the present embodiment are described with reference to the accompanying drawings by taking a checkout system as an example. The store system is a checkout system (POS system) equipped with a POS terminal carrying out the registration and checkout of commodities in one transaction. The present embodiment is an example applied to the checkout system introduced into a store such as a supermarket and the like.

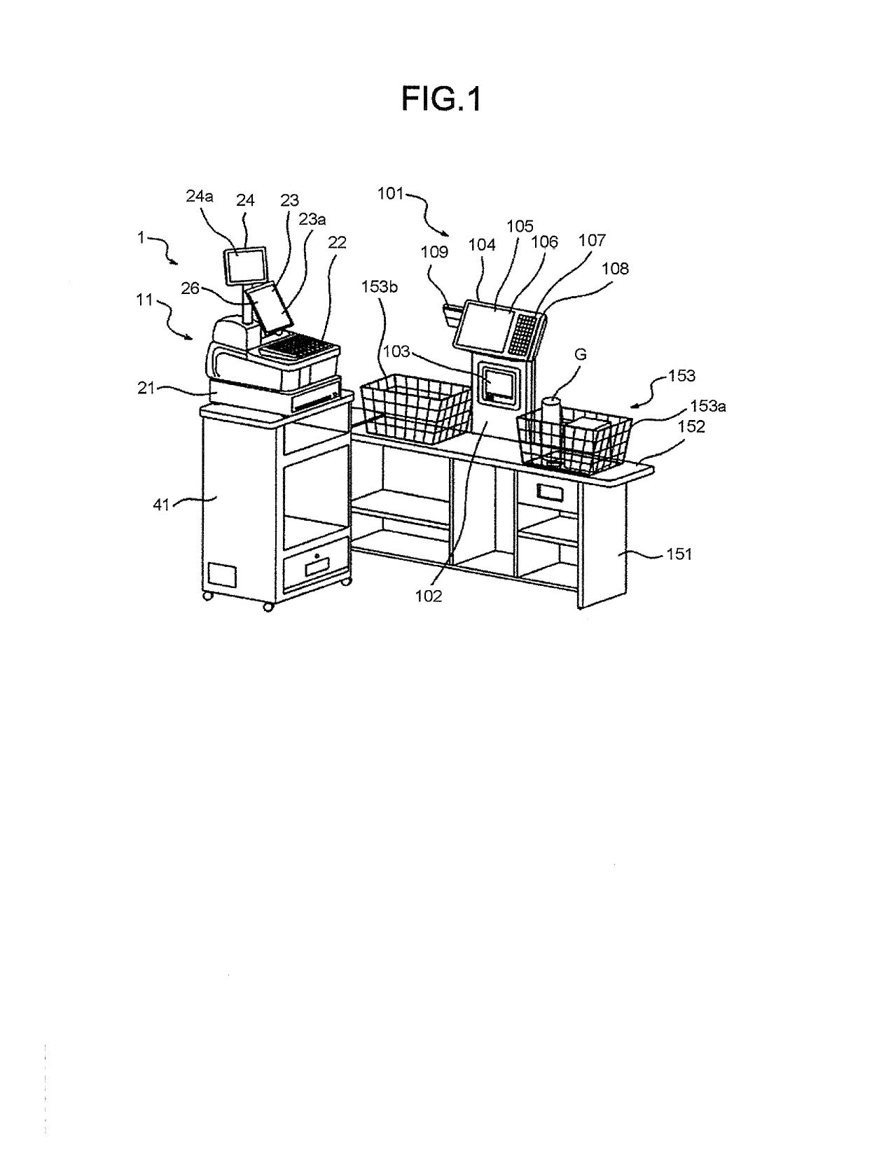

FIG. 1 is a perspective view showing an example of the checkout system 1. As shown in FIG. 1, the checkout system 1 is equipped with a commodity reading apparatus 101 for reading information of the commodity, and the POS terminal 11 for carrying out the registration and checkout of the commodity in one transaction. Hereinafter, an example that the commodity reading apparatus 101 is applied as an information processing apparatus in the present embodiment is described.

The POS terminal 11 is placed on the upper surface of a cash drawer 21 on a checkout counter 41. The open/close operation of the cash drawer 21 is controlled by the POS terminal 11. A keyboard 22 that is operated by an operator (store clerk) is arranged on the upper surface of the POS terminal 11. A display 23 for displaying information to the operator is arranged at a position more backside than the keyboard 22 from the operator who operates the keyboard 22. The display 23 displays information on a screen 23a thereof. A touch panel 26 is laminated on the display screen 23a. A display for customer 24 is vertically arranged at a position more backside than the display 23. The display for customer 24 displays information on the display screen 24a. Moreover, the display screen 24a of the display for customer 24 shown in FIG. 1 faces to the front side in FIG. 1, however, by rotating the display 24, the display screen 24a may face the back side in FIG. 1 to enable the display 24 to show information to a customer.

In the POS system 11, a table-shaped counter 151 having a wide-width is arranged to form L shape with a checkout counter 41 on which the POS terminal 11 is placed. A placing surface 152 is formed on the upper surface of the counter 151. A shopping basket 153 containing a commodity G is placed on the placing surface 152. The shopping basket 153 can be distinguished in use to a first shopping basket 153a that a customer takes onto the counter 151 and a second shopping basket 153b placed at a position opposite to the first shopping basket 153a via the commodity reading apparatus 101. In addition, the shopping basket 153 is not limited to a so-called basket shape and also can be a tray and the like. The shopping basket 153 (the second shopping basket 153b), which is not limited in the shape to an ordinary basket, may also be box-shaped or bag-shaped and the like.

The commodity reading apparatus 101, which is connected with the POS terminal 11 to transmit and receive data with the POS terminal 11, is arranged on the placing surface 152 of the counter 151. The commodity reading apparatus 101 comprises a housing 102 having a rectangular-thin shape. A reading window 103 is arranged at the front side of the housing 102. A display and operation unit 104 is mounted on the upper portion of the housing 102. A display 106 on which a touch panel 105 is laminated is arranged on the display and operation unit 104. A keyboard 107 is arranged at the right side of the display 106. A card reading slot 108 of a card reader (not shown in figures) is arranged at the right side of the keyboard 107. A display 109 for providing information for customer is arranged at the left side of and behind the display and operation unit 104 from the operator who operates the display and operation unit 104.

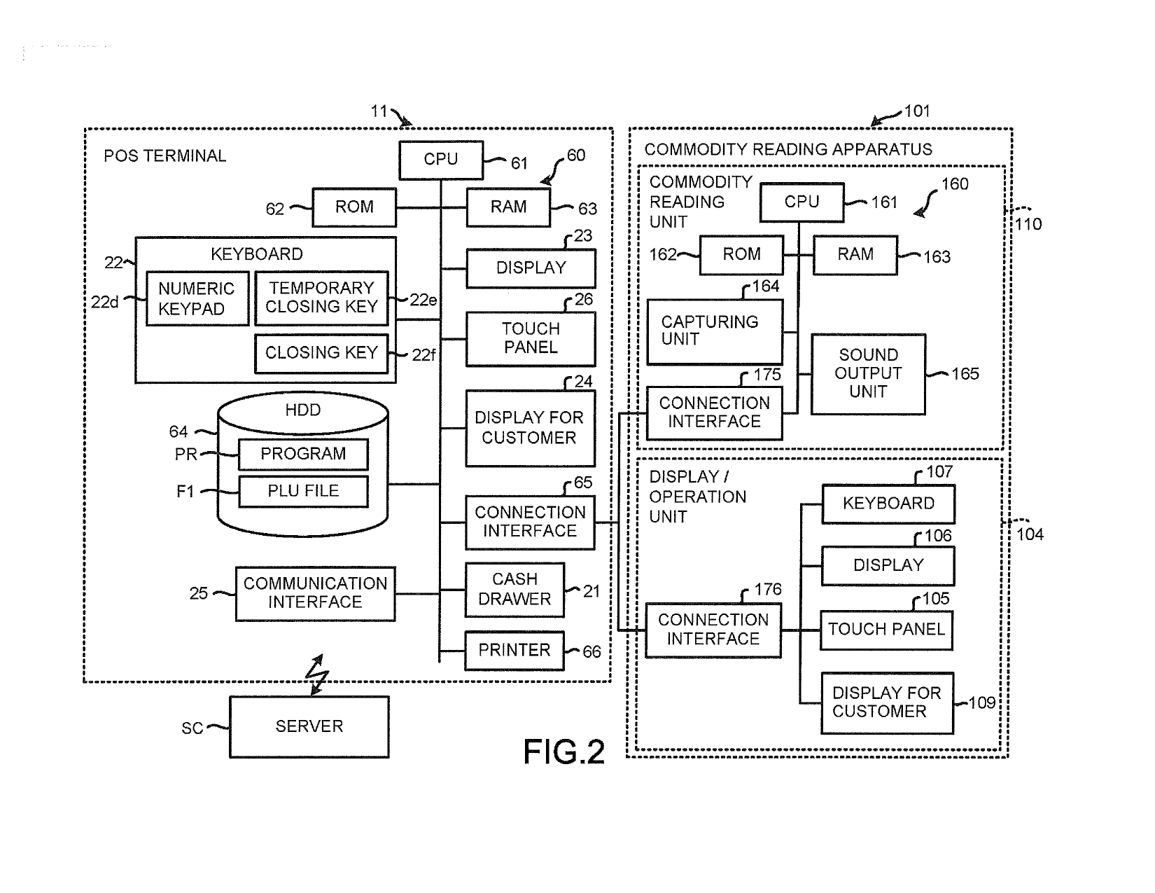

Such a commodity reading apparatus 101 comprises a commodity reading unit 110 (refer to FIG. 2). The commodity reading unit 110 is equipped with an image capturing unit 164 (refer to FIG. 2) at the inside of the reading window 103.

The commodity G in one transaction is contained in the first shopping basket 153a held by the customer. The commodity G in the first shopping basket 153a is moved to the second shopping basket 153b by the operator operating the commodity reading apparatus 101. While the commodity G is moved, the commodity G is enabled to face to the reading window 103 of the commodity reading apparatus 101. At the moment, the image capturing unit 164 (refer to FIG. 2) installed in the reading window 103 captures the commodity G.

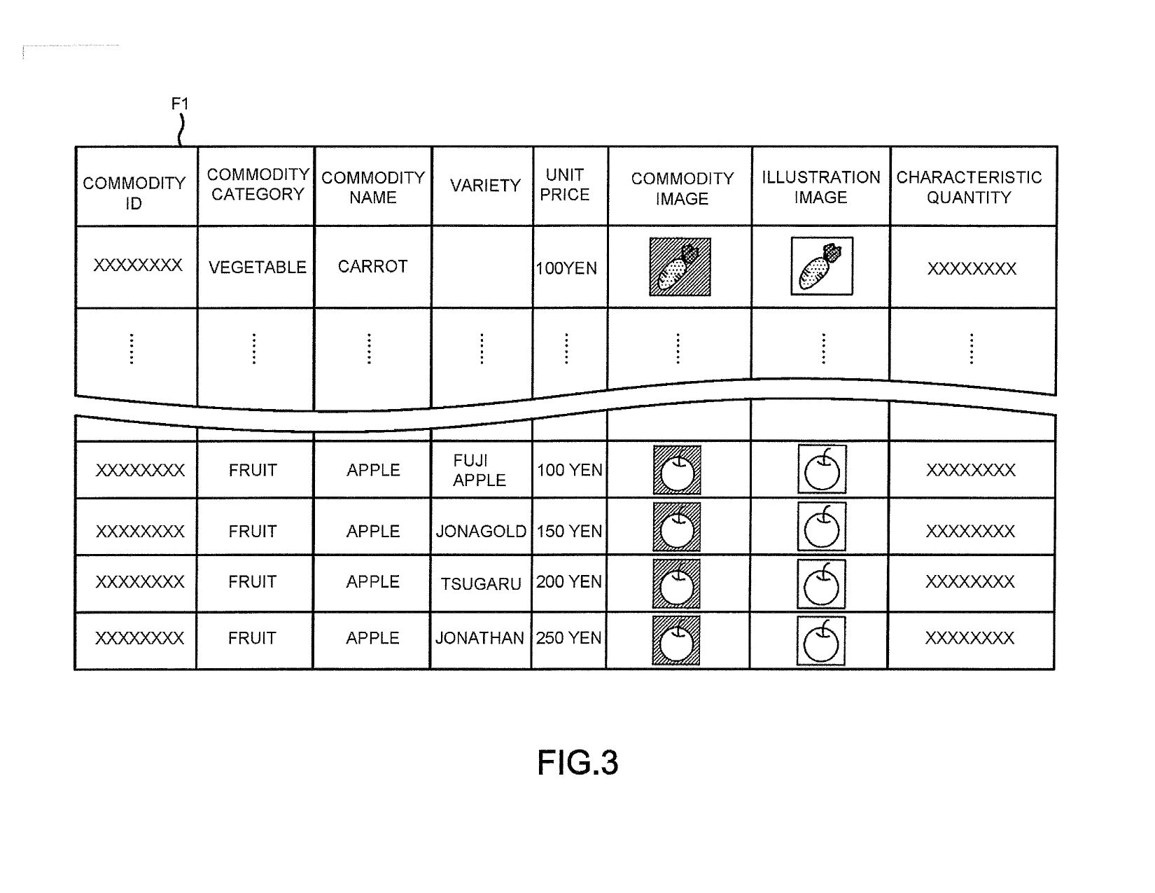

In the commodity reading apparatus 101, a screen for designating that the commodity G included in the image captured by the image capturing unit 164 corresponds which one of the commodities G registered in the following PLU file F1 (refer to FIG. 3) is displayed on the display and operation unit 104, and the commodity ID of the designated commodity is notified to the POS terminal 11. In the POS terminal 11, information relevant with sales registration, such as the commodity category, the commodity name, the unit price and the like of the commodity corresponding to the commodity ID, is recorded in a sales master file (not shown in the figures) and the like based on the commodity ID notified by the commodity reading apparatus 101 to carry out the sales registration.

FIG. 2 is a block diagram showing hardware components of the POS terminal 11 and the commodity reading apparatus 101. The POS terminal 11 comprises a microcomputer 60 which functions as an information processing unit for executing an information processing. The microcomputer 60 includes a structure in which a CPU (Central Processing Unit) 61 for executing various operations to control each other unit is connected to a ROM (Read Only Memory) 62 and a RAM (Random Access Memory) 63 through a bus line.

The above-mentioned cash drawer 21, the keyboard 22, the display 23, the touch panel 26 and the display for customer 24 are all connected with the CPU 61 of the POS terminal 11 through various input and output circuits (all not shown in the figures). These devices or units are controlled by the CPU 61.

The keyboard 22 includes numeric keypads 22d on the upper surface of which numerals “1”, “2”, “3” . . . and operators such as “x” are displayed, a temporary closing key 22e and a closing key 22f.

The CPU 61 of the POS terminal 11 is connected with an HDD (Hard Disk Drive) 64. Programs and various files are stored in the HDD 64. The programs and the various files stored in the HDD 64 are wholly or partially copied to the RAM 63 to be sequentially executed by the CPU 61 when the POS terminal 11 is activated. An example of the programs stored in the HDD 64 is a program PR for processing commodity sales data. An example of the files stored in the HDD 64 also is the PLU file F1 which is transmitted from a store computer SC to the POS terminal and then stored in the HDD 64.

The PLU file F1 is a commodity file used as a dictionary in which the sales registration information of each of the commodity G which is displayed and sold in the store is associated with the image of the commodity G.

FIG. 3 is a conceptual diagram illustrating an example of data compositions of the PLU file F1. As shown in FIG. 3, the PLU file F1 stores information as the commodity information of each commodity G such as the commodity ID uniquely assigned to each commodity, the commodity category to which the commodity G belongs, the commodity name, the unit price and the like, a commodity image (reference image) that the commodity is captured, the illustration image showing the commodity and a characteristic quantity such as a hue or a surface concave-convex status (surface-roughness) and the like read from the captured commodity image and the reference image according to each commodity G. Besides, the characteristic quantity is used for similarity determination described later. In addition, the PLU file F1 is formed to be capable of being read out by the commodity reading apparatus 101 through the following connection interface 65.

If it is required to recognize (detect) not only the category of the article commodity) but also the variety of the article, as shown in FIG. 3, the PLU file F1 manages information of the commodity, such as an commodity name and a unit price and the like, a commodity image (reference image) that the commodity is captured, an illustration image showing the commodity, and a characteristic quantity according to each variety. For instance, in the situation that the category of the article (commodity) is “apple”, information of the commodity, such as the commodity name and the unit price and the like, the commodity image (reference image) capturing the commodity, the illustration image showing the commodity, and the characteristic quantity are managed according to each variety such as “Fuji”, “Jonagold”, “Tsugaru” and “Kougyoku”.

Referring back to FIG. 2, the CPU 61 of the POS terminal 11 is connected with a communication interface 25 for performing a data communication with the store computer SC through an input and output circuit (not shown in the figures). The store computer SC is installed in a backyard of the store. The PLU file F1 to be sent to the POS terminal 11 is stored in the HDD (not shown in the figures) of the store computer Sc.

The CPU 61 of the POS terminal 11 is connected with the connection interface 65 which enables a data transmission and reception with the commodity reading apparatus 101. The connection interface 65 is connected with the commodity reading apparatus 101. In addition, the CPU 61 of the POS terminal 11 is connected with a printer 66 for printing receipts and the like. The POS terminal 11 prints the content of one transaction on a receipt under the control of the CPU 61.

The commodity reading apparatus 101 further comprises a microcomputer 160. The microcomputer 160 includes a structure in which a CPU 161 is connected to a ROM 162 and a RAM 163 via a bus line. Programs executed by the CPU 161 are stored in the ROM 162. The image capturing unit 164 and a sound output unit 165 are connected with the CPU 161 through various input and output circuits (all not shown in the figures). The image capturing unit 164 and the sound output unit 165 operate under the control of the CPU 161. The display and operation unit 104 is connected with the commodity reading unit 110 and the POS terminal 11 through a connection interface 176. The display and operation unit 104 is controlled by the CPU 161 of the commodity reading unit 110 and the CPU 61 of the POS terminal 11.

The image capturing unit 164 is a color CCD image sensor or a color CMOS image sensor and the like, and is an image capturing means for carrying out capturing through the reading window 103 under the control of the CPU 161. For instance, the capturing of a 30 fps motion picture image is carried out by the image capturing unit 164. Frame images (captured images) captured by the image capturing unit 164 in sequence with a given frame rate are stored in the RAM 163.

The sound output unit 165 consists of a sound circuit and a loudspeaker for radiating a given warning sound. The sound output unit 165 informs events with the warning sound or a voice under the control of the CPU 161.

In addition, the CPU 161 is connected with a connection interface 175 which is connected with the connection interface 65 of the POS terminal 11 to transmit and receive data with the POS terminal 11. The CPU 161 performs transmission and reception of data with the display and operation unit 104 through the connection interface 175.

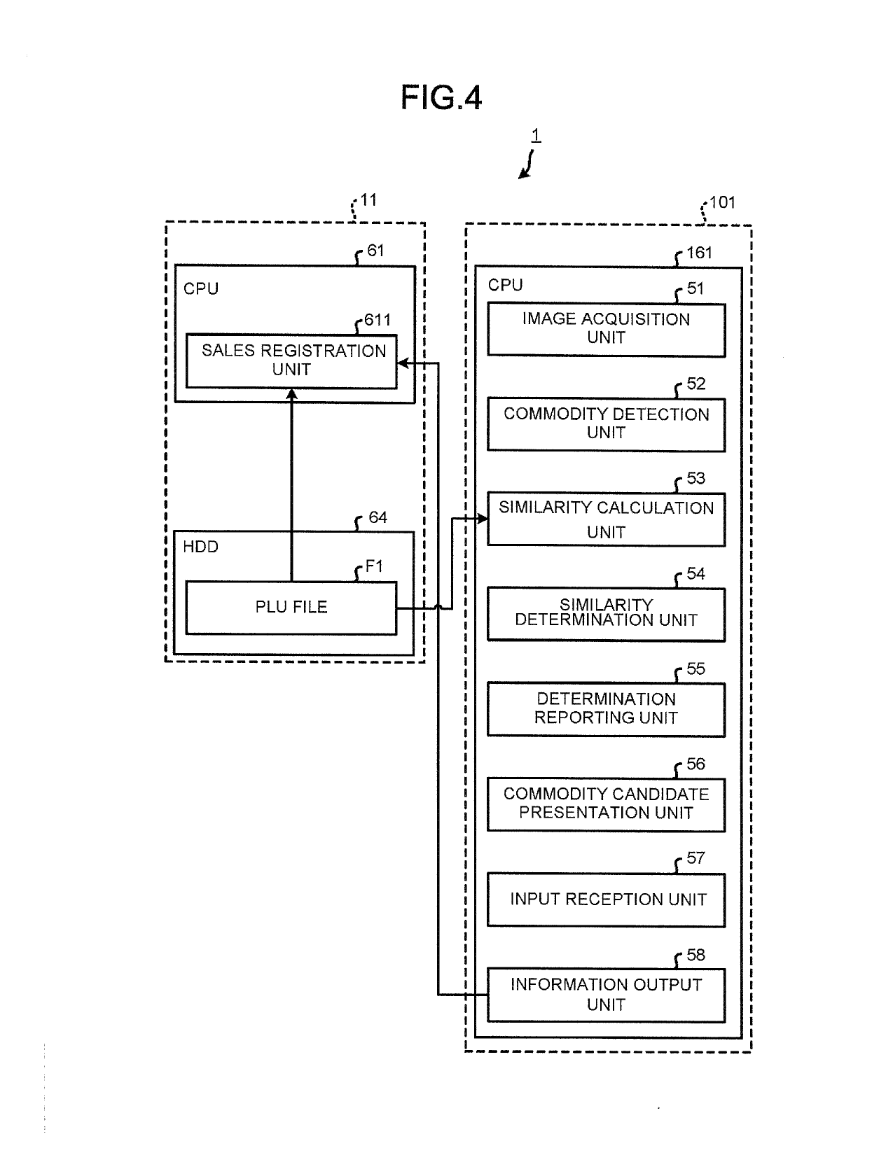

Next, the functional components of the CPU 161 and the CPU 61 realized by executing programs by the CPU 161 and the CPU 61 are described below with reference to FIG. 4.

FIG. 4 is a block diagram showing functional components of the POS terminal 11 and the commodity reading apparatus 101. As shown in FIG. 4, by executing program stored in the ROM 162, the CPU 161 of the commodity reading apparatus 101 functions as an image acquisition unit 51, a commodity detection unit 52, a similarity calculation unit 53, a similarity determination unit 54, a determination reporting unit 55, a commodity candidate presentation unit 56, an input reception unit 57 and an information output unit 58 and in the same way, the CPU 61 of the POS terminal 11 functions as a sales registration unit 611 (sales registration processing means) by executing the program PR.

The image acquisition unit 51 functions as an acquiring means and outputs a capturing-on signal to the image capturing unit 164, so that the image capturing unit 164 starts an image capturing operation. The image acquisition unit 51 acquires the frame images, that are captured by the image capturing unit 164 and are stored in the RAM 163, in sequence, after the capturing operation starts. The acquisition of the frame images, which is executed by the image acquisition unit 51, is carried out according to the order that the frame images are stored in the RAM 163.

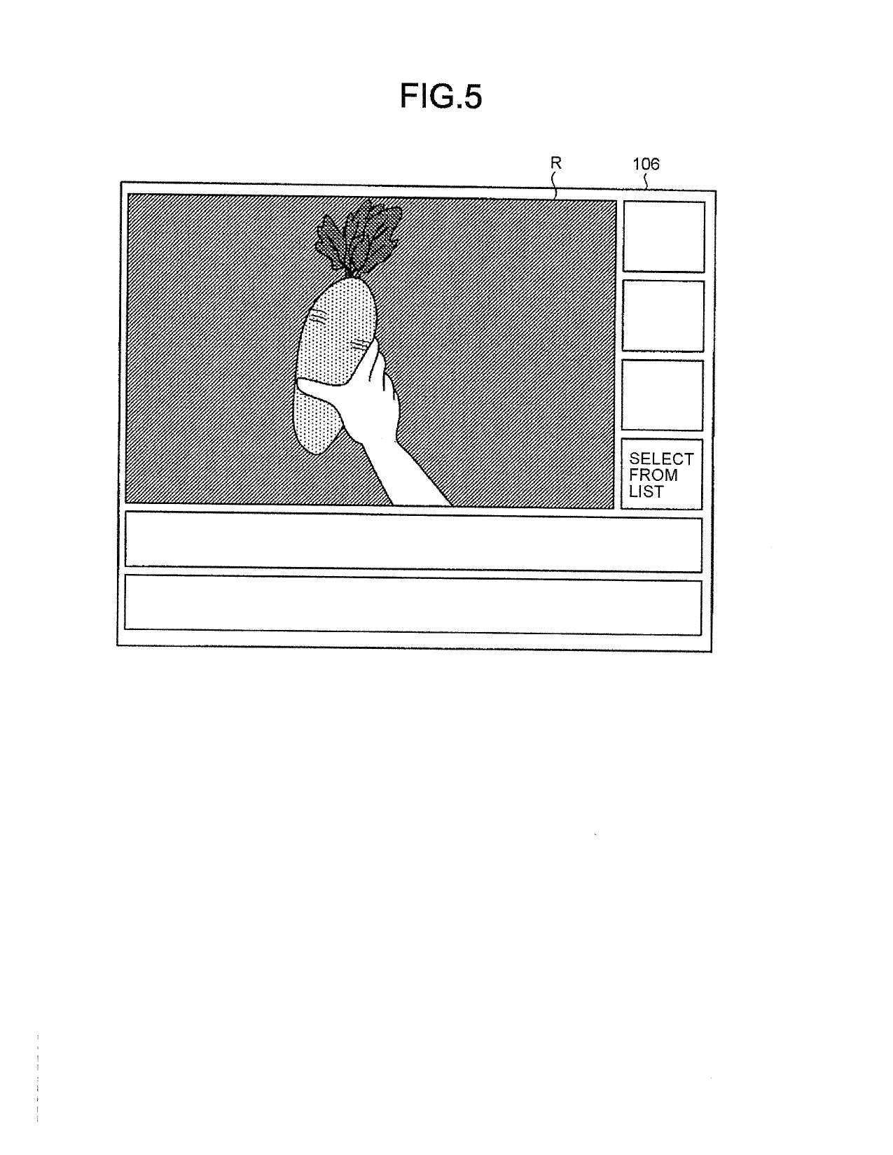

FIG. 5 is a view showing an example of the frame image acquired by the image acquisition unit 51. As shown in FIG. 5, when the operator holds the commodity G to the reading window 103, whole or part of the commodity G is captured in a reading region R of the image capturing unit 164 and is displayed on the display 106 of the commodity reading apparatus 101.

The commodity detection unit 52 detects whole or part of the commodity G included in the frame image acquired by the image acquisition unit 51 by utilizing a pattern matching technology and the like. Particularly, an outline and the like are extracted from the image in which the acquired frame image is performed with a binarize process. Next, the outline extracted from a last time frame image is compared with the outline extracted from a this time frame image to detect the commodity which faces to the reading window 103 for the sales registration.

In addition, as other method detecting the commodity, the existence of a skin color region is detected from the acquired frame image. If the skin color region is detected, that is, hand of the store clerk is detected, the extraction of the outline of the commodity supposed to be grabbed by the hand of the store clerk is tried by carrying out the detection of the above-mentioned outline near the skin color region. At the moment, if the outline showing the shape of the hand and the outline of other object near the outline of the hand are detected, the commodity is detected according to the outline of the other object.

The similarity calculation unit 53 functions as the similarity calculation means and reads a surface state such as the hue or the surface concave-convex status and the like of the commodity G from whole or part of the image of the commodity G captured by the image capturing unit 164 as the characteristic quantity. In order to shorten the processing time, the similarity calculation unit 53 does not consider the outline or the size of the commodity G.

The similarity calculation unit 53 calculates the similarity of the commodity G and the commodity registered in the PLU file F1 (hereinafter referred to as a registered commodity) by comparing the characteristic-quantity which is the surface state of the commodity image of each registered commodity such as a hue or the surface roughness and the like with the characteristic quantity of the commodity G. Herein, the similarity represents the degree of similarity in which whole or part of the image of the commodity G is similar in amount to the image of the registered commodity if the commodity image of each commodity stored in the FLU file F1 is set to be 100%=“similarity: 1.0”. In addition, for instance, in each weight applied to the hue and the surface concave-convex status (surface roughness), the similarity may be calculated by a weight different from each other.

The recognition of the object included in the image in this way is called as a generic object recognition. For such generic object recognition, various recognition technologies are described in the following literature.

Yanai Keiji, “present state and perspectives of generic object recognition”, collected papers of information processing society, Vol. 48, No. SIG16 [retrieved on August 10, Heisei 22 (2010)], website <URL: http://mm.cs.uec.ac.jp/IPSJ-TCVIM-Yanai.pdf>.

In addition, a technology of the generic object recognition by carrying out region segmentation on the image aiming at each target is described in the following literature.

Jamie Shotton, et al., “Semantic Texton Forests for Image Categorization and Segmentation”, [retrieved on August 10, Heisei 22 (2010)], website <URL: http://citeseerx.ist.psu.edu/viewdoc/download?doi=10.1.1.145.3036&rep=rep1&type=pdf>.

In addition, a calculation method for the similarity of the image of the captured commodity G and the registered commodity in the PLU file F1 is not particularly limited. For instance, the similarity of the image of the captured commodity G and each registered commodity in the PLU file F1 can be calculated as an absolute evaluation or also can be calculated as a relative evaluation.

In the case that the similarity is calculated as the absolute evaluation, the image of the captured commodity G is compared with each commodity registered in the PLU file F1 one to one, and the similarity obtained from the result of the comparison is directly adopted. In the case that the similarity is calculated as the relative evaluation, if five commodities (commodities GA, GB, GC, GD and GE) are registered in the PLU file F1, the calculation is carried out in the way of enabling the similarity of the captured commodity G and the commodity GA to be 0.6, the similarity of the captured commodity G and the commodity GB to be 0.1, the similarity of the captured commodity G and the commodity GC to be 0.1, the similarity of the captured commodity G and the commodity GD to be 0.1, the similarity of the captured commodity G and the commodity GE to be 0.1, and the like, and the sum of the similarity of the captured commodity G to each registered commodity to be 1.0 (100%).

The similarity determination unit 54 functions as a determination means and compares the similarity of the image of the commodity G and the commodity image registered in the PLU file F1 for each frame image acquired by the image acquisition unit 51. In the present embodiment, a plurality of conditions are set step by step for the similarity of the commodity image of the registered commodity and the image of the commodity G, and the similarity determination unit 54 carries out the determination of the registered commodity or the selection of the candidate of the commodity according to the condition being met. The conditions of the similarity are not particularly limited, but the situation of using conditions (a to d) is described hereinafter.

The condition “a” and the condition “b” are a first condition according to the present embodiment and is used for determining the commodity G captured by the image capturing unit 164 as one commodity in the registered commodities in the PLU file F1. In addition, the condition “c” is a second condition according to the present embodiment and is used for extracting the candidate of the commodity G captured by the image capturing unit 164 in case that a plurality of articles of different varieties belonging to the same category (commodity) are not included in the commodities registered in the PLU file F1. Moreover, the condition “d” is a third condition according to the present embodiment and is used for extracting the candidate of the commodity G captured by the image capturing unit 164 in case that a plurality of articles of the different varieties belonging to the same category (commodity) are included in the candidate of the commodity meeting the condition “c”.

The similarity determination unit 54 judges (determines) the registered commodity meeting the condition “a” or the condition “b” as the commodity (hereinafter referred to as a determined commodity) corresponding to the commodity G captured by the image capturing unit 164 one to one. The similarity determination unit 54 determines the registered commodity meeting the condition “c” as a candidate of the commodity G (hereinafter referred to as a candidate commodity) captured by the image capturing unit 164 rather than the determined commodity. Afterwards, the candidate commodity to the commodity G is extracted by extracting the registered commodity meeting the condition “c” from a plurality of registered commodities in the PLU file F1.

The similarity unit 54 also judges the registered commodity meeting the condition “d” (article of different varieties belonging to the same category (commodity)) as a candidate of the commodity G captured by the capturing unit 164 rather than the determined commodity. Afterwards, the candidate commodity to the commodity G is extracted by extracting the registered commodity meeting the condition “d” from the plurality of registered commodities in the PLU file F1.

Details of the conditions “a”-“c” are not particularly limited so long as the conditions “a”-“c” are set step by step according to the similarity, and as an example, the conditions “a”-“c” can be set by a plurality of preset threshold values. Herein, a case that the conditions “a”-“c” are respectively set by a first threshold value to a third threshold value is described. A relationship in size or amount of the first threshold value to the third threshold value is set to be that a second threshold value is less than the first threshold value but more than the third threshold value (first threshold value>second threshold value>third threshold value).

The similarity determination unit 54 counts the number of times that the similarity of the commodity image and the registered commodity is greater than or equal to the preset first threshold value (such as 90%) and determines that the condition “a” is met when the number of times counted is greater than or equal to a specified number of times. In addition, in case that the first threshold value is set adequately at high in the way that an erroneous determination cannot occur, the specified number of times may be set to be one to determine the condition “a”.

If the similarity of the commodity image and the registered commodity is less than the first threshold value (such as 90%) but greater than or equal to the second threshold value (such as 75%) less than the first threshold value, the similarity determination unit 54 determines that the condition “b” is met. Moreover, the registered commodity meeting the condition “b” is the determined commodity, but is determined to need a confirmation operation by the operator. In addition, the number of times that the similarity of the commodity image and the registered commodity is less than the first threshold value (such as 90%) but greater than or equal to the second threshold value (such as 75%) less than the first threshold value is counted, and if the number of times (counted value) is more than or equal to a specified number of times, the condition “b” may be determined to be met.

Furthermore, if the similarity of the commodity image and the registered commodity is less than the second threshold value (such as 75%) but greater than or equal to the third threshold value (such as 10%) less than the second threshold value, the similarity determination unit 54 determines that the condition “c” is met. Also, the number of times that the similarity of the commodity image and the registered commodity is determined to be less than the second threshold value (such as 75%) but greater than or equal to the third threshold value (such as 10%) less than the second threshold value is counted, and if the number of times counted is greater than or equal to a specified number of times, the condition “c” may be determined to be met.

All the conditions “a”-“c” can be properly set according to the degree or amount of the similarity, the number of times of the determination and the like, but are not limited to the above-mentioned example. The specified number of times used for the determination of the conditions “a”-“c” may be respectively set at different number of times for each condition.

The similarity determination unit 54 adds the similarities of the plurality of varieties in case that the plurality of articles of the different varieties belonging to the same category (commodity) are included in the registered commodity meeting the condition “c”, and determines that the condition “d” is met if the similarity of the category (commodity) obtained by adding the similarities of the plurality of varieties is greater than or equal to the preset second threshold value (such as 75%).

The determination reporting unit 55 functions as a reporting means and reports that the commodity captured by the image capturing unit 164 is uniquely determined as the registered commodity meeting the condition “a” or the condition “b” to the operator or the customer by the image output or sound output and the like.

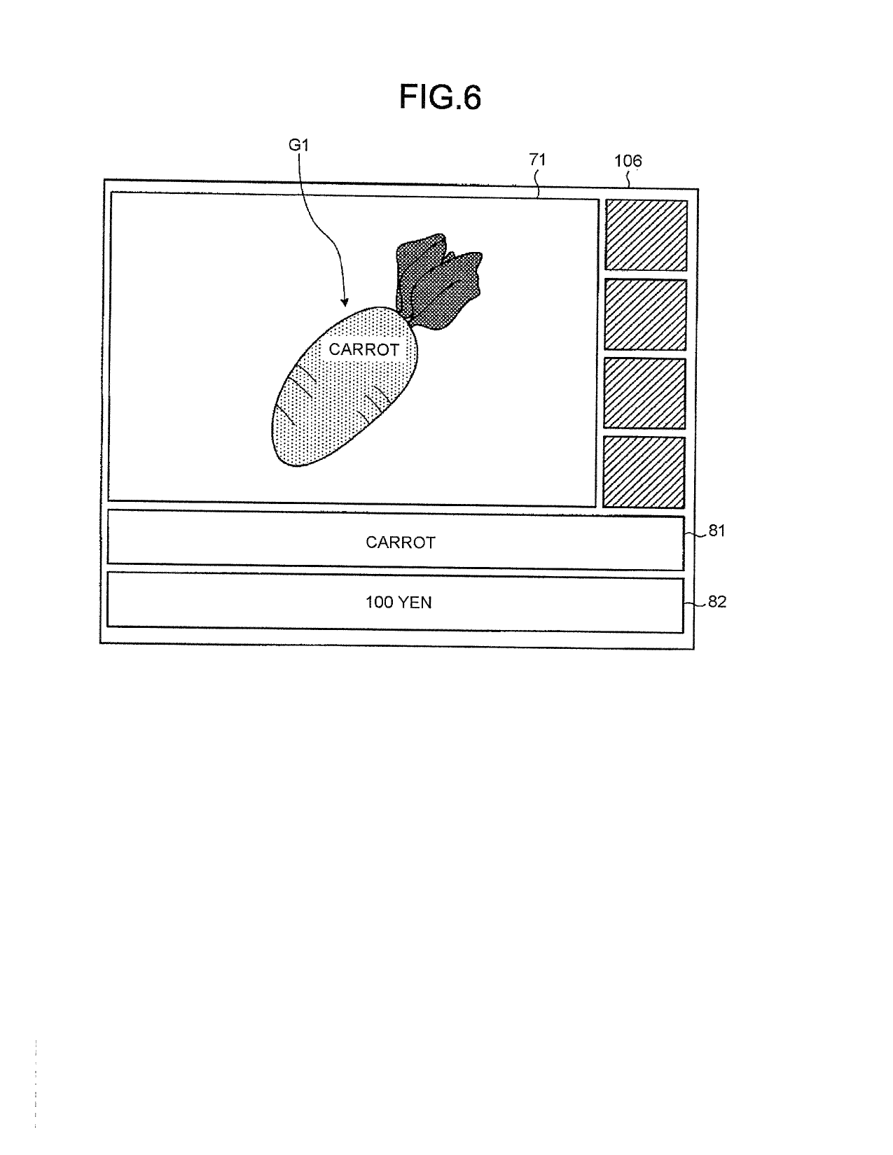

More particularly, the determination reporting unit 55 displays a determination screen 71 (refer to FIG. 6) which shows on the display 106 that the registered commodity meeting the condition “a” is uniquely determined as a commodity (determined commodity) captured by the image capturing unit 164.

FIG. 6 is a diagram showing an example of the determination screen 71. In case that the registered commodity meeting the condition “a” exists, the determination reporting unit 55 stops the display of the captured image in the reading region R (refer to FIG. 5), reads out a illustration image G1 corresponding to the determined commodity and the commodity name “carrot” from the PLU file F1, and displays them on the determination screen 71. In addition, the determination reporting unit 55 respectively displays the commodity name and the commodity price (unit price) of the determined commodity read out of the PLU file F1 on a commodity name display region 81 and a price display region 82. However, the determination reporting unit 55 may also display the commodity image (photograph) read out of the PLU file F1 instead of the display of the illustration image G1.

The determination reporting unit 55 outputs the information relevant with the determined commodity, such as the commodity name and the like read out of the PLU file F1, to the sound output unit 165 in coincidence with the timing of the display of the determination screen 71. The sound output unit 165 informs the information showing the determined commodity to the operator or the customer by outputting the input information.

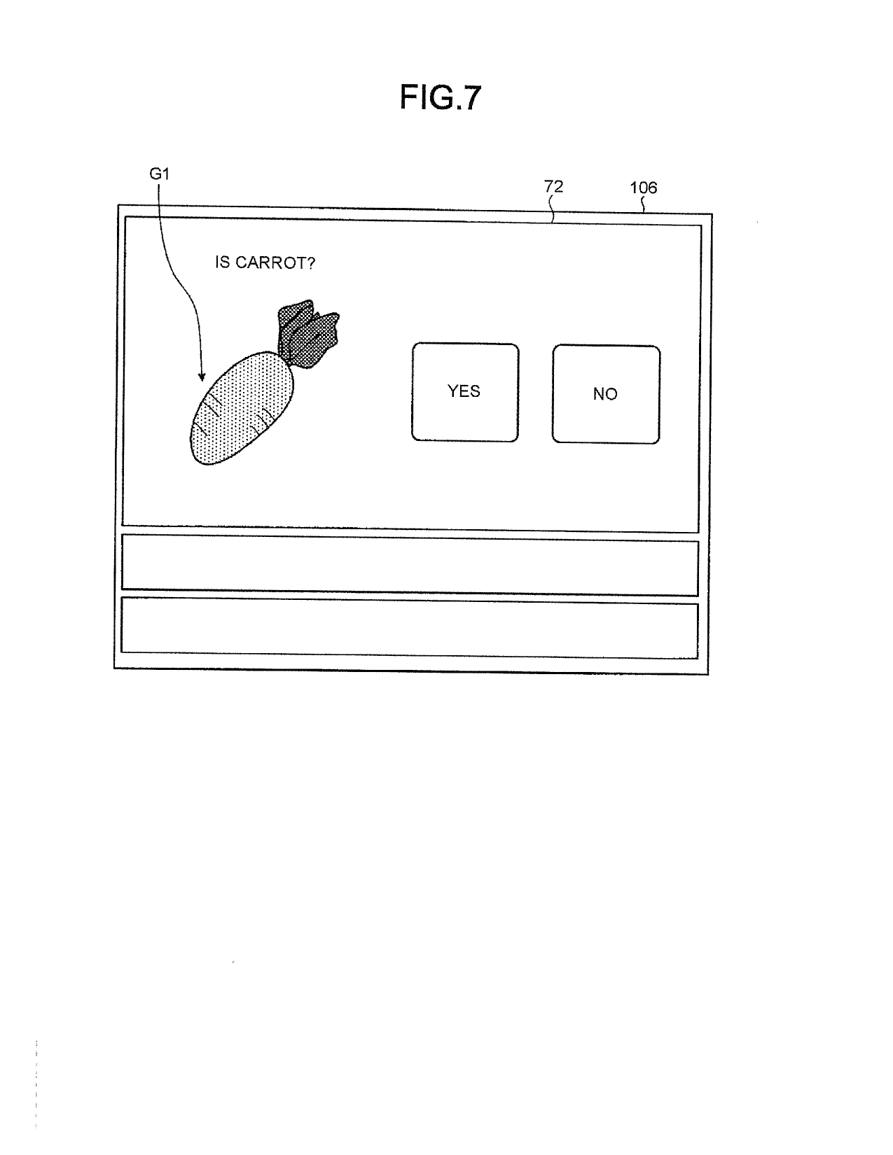

The determination reporting unit 55 displays a confirmation screen 72 (refer to FIG. 7) which receives a final confirmation operation (YES or NO) whether or not the registered commodity (determined commodity) meeting the condition “b” is the commodity G captured by the image capturing unit 164 on the display 106.

FIG. 7 is a diagram showing an example of the confirmation screen 72. When the registered commodity meeting the condition “b” exists, the determination reporting unit 55 reads out the illustration image G1 corresponding to the determined commodity from the PLU file F1 and displays the illustration image G1 on the confirmation screen 72. In addition, the determination reporting unit 55 displays a message inquiring whether or not the read commodity G is the commodity of the illustration image G1 by using the commodity name of the determined commodity readout of the PLU file F1 as “is carrot?” and the like. In addition, buttons, such as “YES” and “NO” buttons and the like, are arranged on the confirmation screen 72 (touch panel 105) in a selectable way by a touch operation to the touch panel 105.

In this way, the result of the similarity determination shows that the commodity name and the commodity image of the registered commodity (determined commodity) which is uniquely selected for one commodity G, and the registered commodity is displayed on the confirmation screen 72 in a one-to-one relationship with the commodity G. Therefore, the confirmation screen 72 reports that the registered commodity meeting the condition “b” is uniquely determined as the commodity G captured by the image capturing unit 164.

In the present embodiment, in such a way, if the commodity captured is uniquely determined, the illustration image of the determined commodity is displayed instead of the captured image. Therefore, the operator can intuitively recognize that the discrimination of the commodity has been determined, and moreover, can recognize, at a glance, the commodity which is discriminated.

The determination reporting unit 55 may make the sound output unit 165 sound-output the information relevant with the determined commodity in coincidence with the timing when the confirmation screen 72 is displayed, but in the determination screen 72, the sound output may not be carried out. Performing the sound output in the determination screen 71 and the confirmation screen 72 may be set properly.

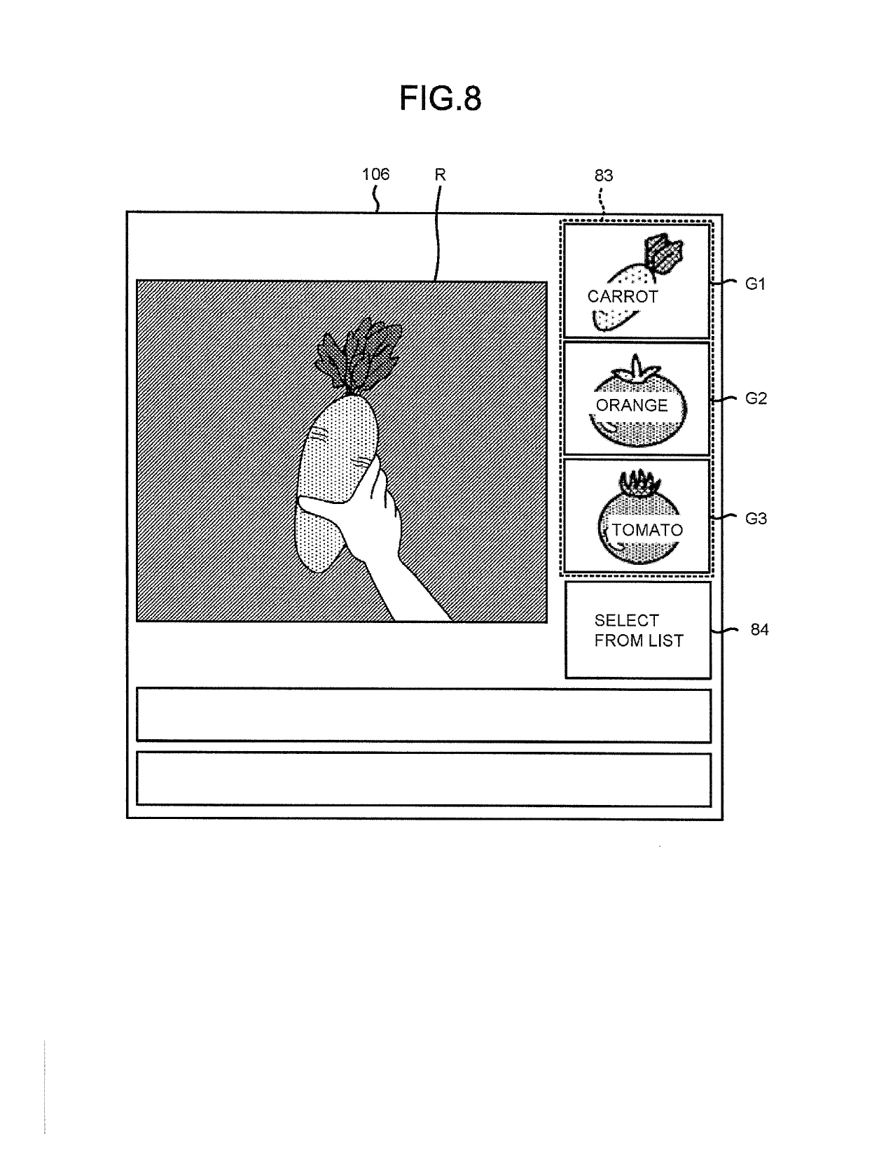

The commodity candidate presentation unit 56 displays the information relevant with the registered commodity meeting the condition “c” on the display 106 as the candidate commodity. More particularly, the commodity candidate presentation unit 56 reads out the illustration image and the commodity name of the registered commodity meeting the condition “c” from the PLU file F1 and outputs in sequence the illustration image and the commodity name of the commodity with a higher similarity calculated by the similarity calculation unit 53 from the candidate commodities to the display 106. The display 106 sequentially displays the illustration image and the commodity name of the candidate commodity outputted in a commodity candidate presentation region 83 (refer to FIG. 8).

FIG. 8 is a diagram showing a screen example displaying the illustration images G1, G2 and G3 of the candidate commodities. As shown in FIG. 8, the illustration images G1, G2 and G3 and each commodity name of the candidate commodity are displayed in the commodity candidate presentation region 83 in sequence from the registered commodity with the higher similarity. These illustration images G1, G2 and G3 are formed to be selectable in response to the selection operation to the touch panel 105. In addition, a selection button 84 used for selecting the commodity from a commodity list is arranged at the lower part of the commodity candidate presentation region 83, and the commodity selected from the commodity list is processed as the above-mentioned determined commodity. An example that three candidate commodities corresponding to the illustration images G1-G3 are displayed is shown in FIG. 8, but the quantity or the display method of the candidate commodities is not particularly limited. In addition, the commodity image (photograph) also can be displayed instead of the illustration image.

If the selection operation to the candidate commodity is not received even if the illustration images G1-G3 of the candidate commodities are displayed on the display 106, the image acquisition processing executed by the image acquisition unit 51, the detection processing executed by the commodity detection unit 52 and the similarity calculation processing executed by the similarity calculation unit 53 are continued. Therefore, while the candidate commodity is not selected, the captured image in the reading region R is displayed on the screen of the display 106.

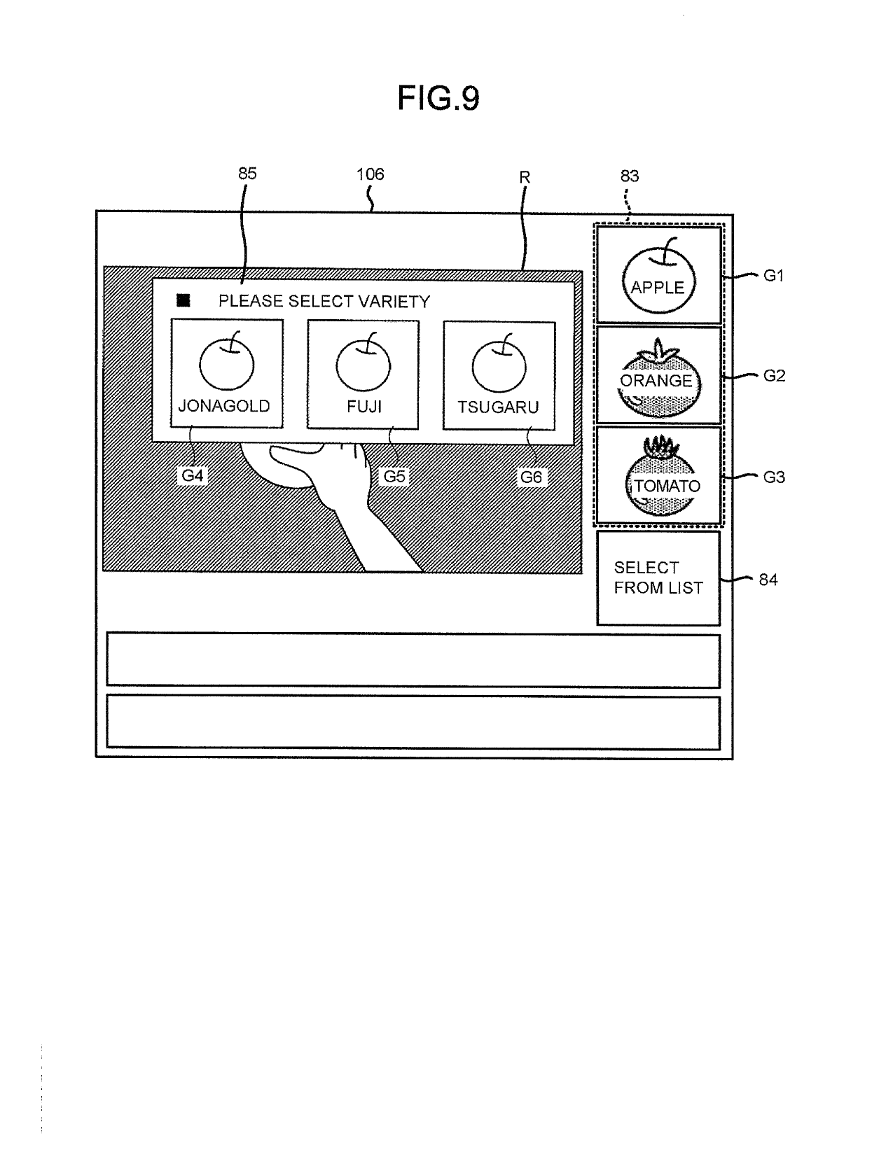

The commodity candidate presentation unit 56 displays information relating to the registered commodity of different varieties belonging to the same category (commodity) meeting the condition “d” on the display 106 as a candidate commodity. In more detail, the commodity candidate presentation unit 56 reads out the illustration image and the commodity name of the registered commodity (article of the different varieties belonging to the same category (commodity)) meeting the condition “d” from the PLU file F1, and sequentially outputs the illustration image and the commodity name from the commodity with a higher similarity calculated by the similarity calculation unit 53 to the display 106. The display 106 displays the illustration image and the commodity name outputted on the variety selection screen 85 (refer to FIG. 9) from the commodity with a higher similarity.

The commodity candidate presentation unit 56 reads out the lustration image and the commodity name of the registered commodity (article of different varieties belonging to the same category (commodity)) from the PLU file, and may sequentially output the illustration image and the commodity name from the commodity with a greater number of times counted, provided that the number of times of the selection of the commodity on the variety selection screen 85 of the display 106 is counted beforehand.

FIG. 9 is a diagram showing an example of variety selection screen of the candidate commodity. As shown in FIG. 9, the illustration images G4, G5 and G6 of the candidate commodities and each variety name which are overlapped on the frame image actually recognized are sequentially displayed on the variety selection screen 85 from the registered commodity with a higher similarity (article of the different varieties belonging to the same category (commodity)). In addition, the similarity also may be displayed on the illustration images G4, G5 and G6 of the candidate commodities. These illustration images G4, G5 and G6 are formed to be selectable in response to the selection operation to the touch panel 105. In FIG. 9, an example that the three candidate commodities (the illustration images G4, G5 and G6) which are articles of the different varieties belonging to the category (commodity) of the illustration image G1 are displayed, but the quantity of the candidate commodity displayed or the display method of the candidate commodity is not particularly limited. If the quantity of the candidate commodity is many, a button “select other variety” or a scroll button also may be arranged, so as to display the illustration image of the candidate commodity in sequence by the operation of the button. In addition, the commodity image (photograph) may also be displayed instead of the illustration image.

The input reception unit 57 functions as a reception means and receives various input operations corresponding to the display of the display 106 via the touch panel 105 or the keyboard 107. For instance, the input reception unit 57 receives the input operation (confirmation operation) finally confirming that the commodity of the displayed illustration image G1 is the determined commodity based on the selection operation to the confirmation screen 72 (refer to FIG. 7). In addition, the determination reporting unit 55 displays the above-mentioned determination screen 71 on the display 106 when the input reception unit 57 receives the confirmation operation.

The input reception unit 57 receives the selection operation to any one of illustration images G1-G3 (refer to FIG. 9) of the candidate commodities displayed on the display 106. When the input reception unit 57 receives the selection operation, the determination reporting unit 55 displays the determination screen 71 which displays the candidate commodity received as a determined commodity on the display 106.

The information output unit 58 outputs the information (such as a commodity ID or a commodity name and the like) showing the commodity to the POS terminal 11 through the connection interface 175 for the commodity determined by the above-mentioned way.

The information output unit 58 may output a sales number separately input through the touch panel 105 or the keyboard 107 together with the commodity ID and the like to the POS terminal 11. In addition, as the information output to the POS terminal 11 by the information output unit 58, the information output unit 58 may directly notify the commodity ID read out of the PLU file F1, or may also notify the commodity name or the commodity image capable of specifying the commodity ID and the file name of the illustration image. Furthermore, the information output unit 58 may notify the storage location of the commodity ID (a storage address in the PLU file F1) to the POS terminal 11.

The sales registration unit 611 of the POS terminal 11 carries out the sales registration of the commodity based on the commodity ID and the sales number output from the information output unit 58. Particularly, the sales registration unit 611 records the notified commodity ID, the commodity category, the commodity name, the unit price and the like corresponding to the commodity ID and the sales number together in the sales master file and the like with reference to the PLU file F1, so as to carry out the sales registration.

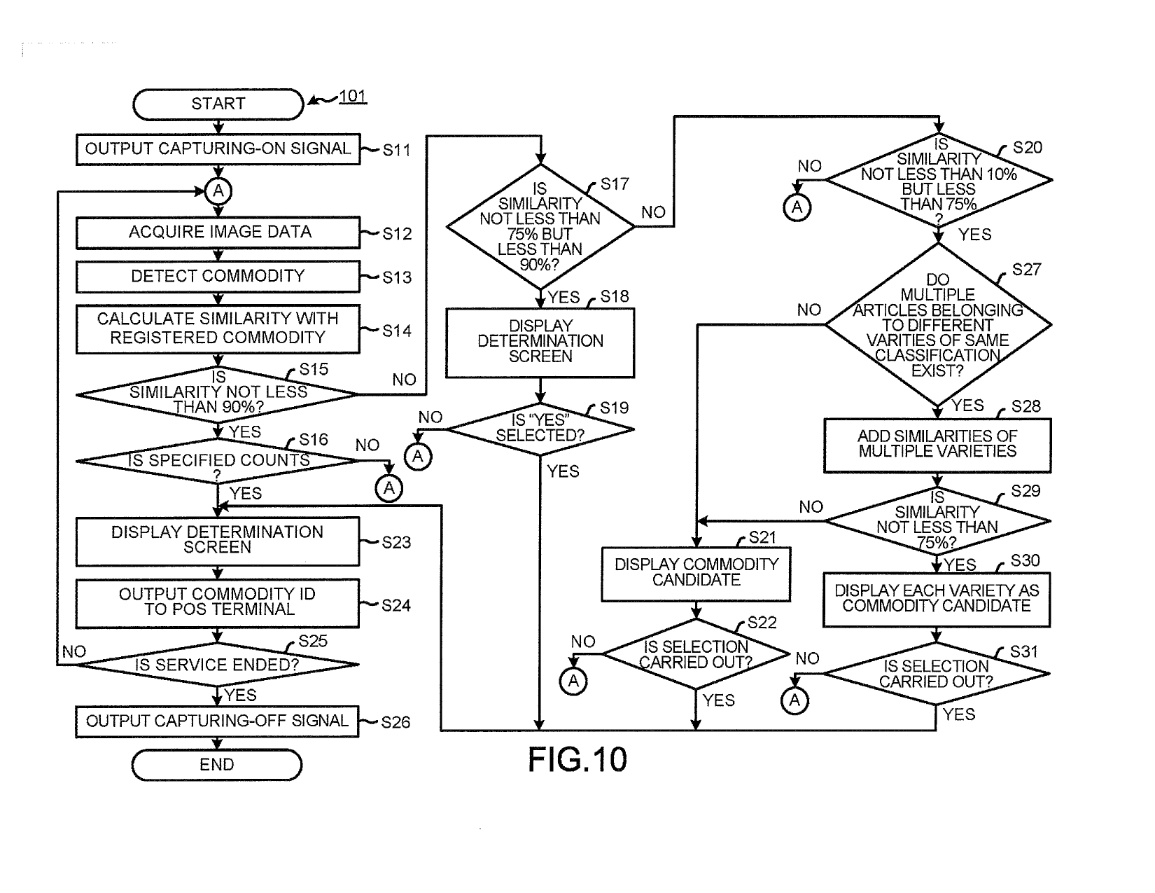

Next, the operations of the checkout system 1 are described in detail. First, the operations of the commodity reading apparatus 101 are described. FIG. 10 is a flow chart showing the procedures of the commodity recognition processing executed by the commodity reading apparatus 101. In FIG. 10, a case that the first threshold value is set to be the similarity 90% (0.90), the second threshold value is set to be the similarity 75% (0.75) and the third threshold value is set to be the similarity 10% (0.10) is described, but each threshold value is not limited to that.

When the processing starts in response to the start of the commodity registration executed by the POS terminal 11, the image acquisition unit 51 outputs a capturing-on signal to the image capturing unit 164, so as to start the capturing executed by the image capturing unit 164 (Act S11).

The image acquisition unit 51 acquires the frame image (captured image), captured by the image capturing unit 164, that is stored in the RAM 163 (Act S12). Next, the commodity detection unit 52 detects whole or part of the commodity G in the frame image acquired by the image acquisition unit 51 (Act S13). Next, the similarity calculation unit 53 reads the characteristic quantity of the commodity G from whole or part of the image of the commodity G and compares the characteristic quantity with the characteristic quantity of each commodity image registered in the PLU file F1, so as to calculate the similarity of the commodity G with the registered commodity (Act S14).

The similarity determination unit 54 determines whether or not there is a registered commodity whose similarity is greater than or equal to 90% (Act S15). When the registered commodity whose similarity is greater than or equal to 90% does not exist (Act S15: NO), the processing in an Act S17 is taken. When the registered commodity whose similarity is greater than or equal to 90% exists (Act S15: YES), it is determined whether or not the number of times that the similarity to the same registered commodity is greater than or equal to 90% is more than a specified number of times (such as 3 times) (Act S16). When the number of times counted does not reach at the specified number of times (Act S16: NO), the processing in the Act S12 is taken, and the image acquisition unit 51 acquires a new frame image captured by the image capturing unit 164.

When the number of times counted reaches at the specified number of times (Act S16: YES), the determination reporting unit 55 displays the determination screen 71 (refer to FIG. 6) including the illustration image of the determined commodity, and reports the determined commodity by carrying out the sound notification on the commodity name of the determined commodity (Act S23). In addition, the information output unit 58 outputs the commodity ID of the registered commodity judged as the determined commodity together with the sales number separately input-through the keyboard 107 to the POS terminal 11 (Act S24), and afterwards, the processing in an Act S25 is taken.

If NO is taken in the Act S15, the similarity determination unit 54 determines whether or not there is a registered commodity whose similarity is more than or equal to 75% but less than 90% (Act S17). If there is a registered commodity whose similarity is in this range (Act S17: YES), the registered commodity is determined as the determined commodity needing the confirmation by the operator, and the confirmation screen 72 is displayed on the display 106 (Act S18). The input reception unit 57 determines whether or not “YES” is selected on the confirmation screen 72 (refer to FIG. 7) (Act S19). When “YES” is selected (Act S19: YES), the processing in the Act S23 is taken, and the determination reporting unit 55 displays the determination screen 71. On the other hand, if “NO” is selected (Act S19: NO), the processing in the Act S12 is taken.

If the registered commodity whose similarity is more than or equal to 75% but less than 90% does not exist (Act S17: NO), the similarity determination unit 54 determines whether or not there is a registered commodity whose similarity is more than or equal to 10% but less than 75% exists and extracts the registered commodity whose similarity is within this range as a candidate commodity of the commodity G (Act S20). However, if the registered commodity within this range does not exist (Act S20: NO), the processing in the Act S12 is taken.

When the registered commodity whose similarity is more than or equal to 10% but less than 75% exists (Act S20: YES), the similarity determination unit 54 determines whether or not there are a plurality of articles of different varieties belonging to the same category (Act S27). If the plurality of articles of different varieties belonging to the same category do not exist (Act S27: NO), the similarity determination unit 54 determines the registered commodity concerned as the candidate commodity of the commodity G. Afterwards, the commodity candidate presentation unit 56 sorts the illustration images and the commodity names of the registered commodities determined as the candidate commodity in a descending order of the similarity and displays them on the commodity candidate presentation region 83 (Act S21).

The input reception unit 57 determines whether or not the selection operation to the commodity image of the registered commodity is received (Act S22). If the selection operation is received (Act S22: YES), the processing in the Act S23 is taken, and the determination reporting unit 55 displays the determination screen 71. On the other hand, when the selection operation is not received (Act S22: NO), the processing in the Act S12 is taken.

If there is a plurality of articles of different varieties belonging to the same category (Act S27: YES), the similarities of the plurality of varieties concerned are added (Act S28), and when the similarity added is greater than or equal to the preset second threshold value (such as 75%) (Act S29: YES), the similarity determination unit 54 determines the plurality of articles of different varieties belonging to the same category as a candidate commodity of the commodity G. Afterwards, the commodity candidate presentation unit 56 sorts the illustration images and the commodity names of the registered commodities (articles of different varieties belonging to the same category (commodity)) determined as a candidate commodity in the descending order of the similarity and displays the variety selection screen 85 on the commodity candidate presentation region 83 (Act S30).

The input reception unit 57 determines whether or not the selection operation to the commodity image of the registered commodity (article of different variety belonging to the same category (commodity)) is received (Act S31). If the selection operation is received (Act S31: YES), the processing in the Act S23 is taken, and the determination reporting unit 55 displays the determination screen 71. On the other hand, if the selection operation is not received (Act S31: NO), the processing in the Act S12 is taken.

In the Act S25, the CPU 161 determines whether or not there is a service termination, e.g., termination-notification of the commodity registration from the POS terminal 11. When a service is continued (Act S25: NO), the CPU 161 returns the processing to the Act S12 and continues the processing. If the service is terminated (Act S25: YES), the image acquisition unit 51 outputs a capturing-off signal to the image capturing unit 164 to terminate the capturing executed by the image capturing unit 164 (Act S26), and then terminates the processing.

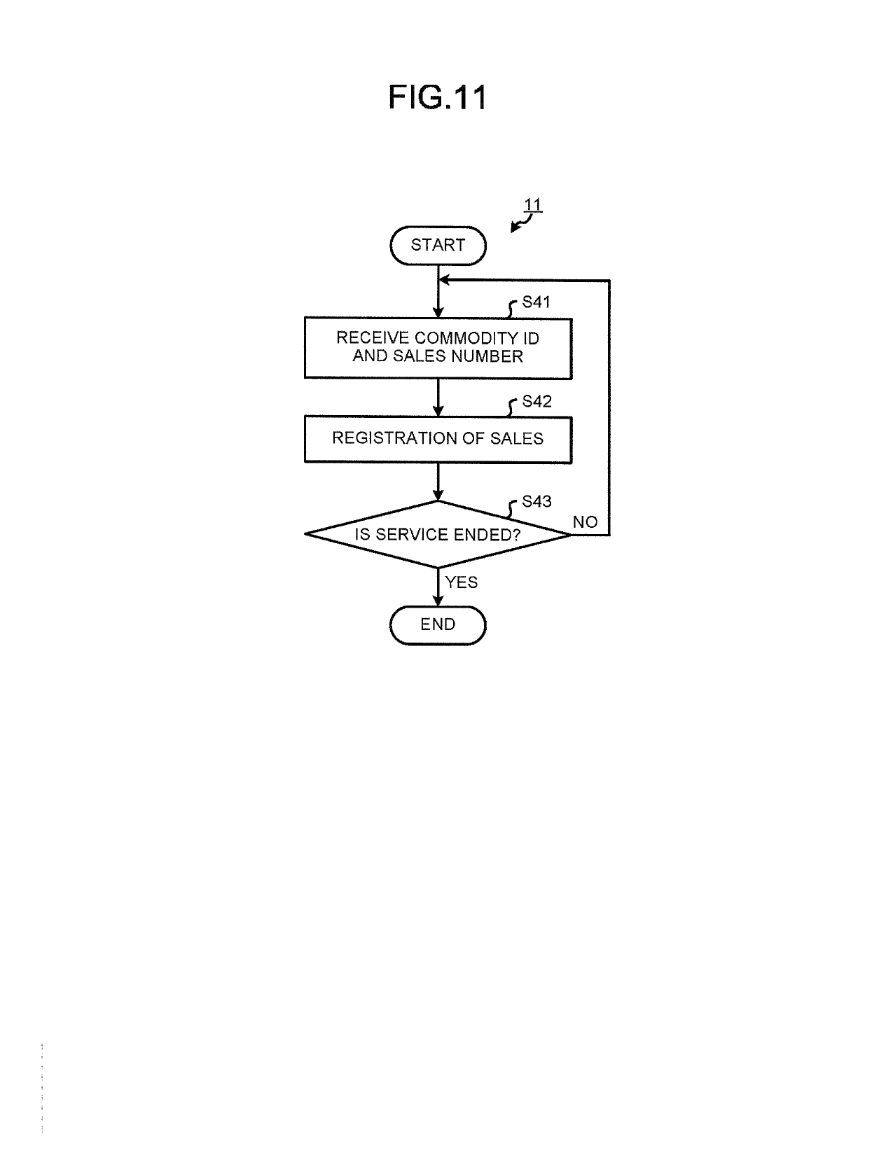

Next, the operations of the POS terminal 11 are described. FIG. 11 is a flow chart showing the procedures of the sales registration processing executed by the POS terminal 11.

First, when the processing starts in response to a start of the commodity registration by the operation instruction on the keyboard 22, the CPU 61 receives the commodity ID and the sales number of the determined commodity output by the commodity reading apparatus 101 in a Act S24 in FIG. 10 (Act S41). Next, the CPU 61 (sales registration unit 611) reads out a commodity category and the unit price and the like from the PLU file F1 based on the commodity ID and the sales number received in the Act S41 and registers the sale of the commodity G read by the commodity reading apparatus 101 in the sales master file (Act S42). Next, the CPU 61 determines whether or not there is the service termination, e.g., termination of the sales registration by the operation instruction on the keyboard 22 (Act S43). When the service is continued (Act S43: NO), the CPU 61 returns to the Act S41 again to continue the processing. When the service is terminated (Act S43: YES), the CPU 61 terminates the processing.

As described above, according to the present embodiment, if the plurality of articles of different varieties belonging to the same superior (upper level) category are included in the candidate of the commodity meeting the second condition extracting the candidate of the captured commodity, it is determined whether or not the similarity of the superior category obtained by adding the similarities of the plurality of varieties concerned meets the third condition extracting the candidate of the captured commodity from the plurality of varieties, and if the third condition is met, the information relevant with the commodity, corresponding to the reference image that meets the third condition is reported as a candidate of the captured commodity. Therefore, if the third condition is met, the article of different variety belonging to the same superior category is set as one article, no matter which variety is recognized, the superior category of the variety can be recognized, and therefore, the recognition rate of the article can be improved.

In the above-mentioned embodiment, the case that the commodity G is captured one by one in the commodity reading apparatus 101 is described, but the number of commodities G captured at once is not particularly limited, and a plurality of commodities G also can be captured at once. In the case that a plurality of commodities G are captured at the same time, the similarities of the plurality of commodities G and the images (G1, G2, G3, . . . ) of the registered commodities are respectively calculated, and a calculation result and the above-mentioned threshold values are compared to select a determined commodity or a candidate commodity.

The composition of each above-mentioned display screen is not limited to the examples in FIG. 5 to FIG. 9, and a case that a display region used for displaying other elements and an operation button are arranged also can be adopted.

In the above-mentioned embodiment, the case that the POS terminal 11 includes the PLU file F1 is adopted, but it is not limited to that, a case that the commodity reading apparatus 101 includes the PLU file F1 also can be adopted, or a case that an external apparatus which can be accessed by the POS terminal 11 and the commodity reading apparatus 101 includes the PLU file F1 further can be adopted.

In the above-mentioned embodiment, the commodity reading apparatus 101 is applied as the information processing apparatus including functions of the similarity calculation unit 53 and the similarity determination unit 54, but it is not limited to that, and the POS terminal 11 also can be applied as the information processing apparatus including functions of the similarity calculation unit 53 and the similarity determination unit 54 to output the calculation result and the determination result to the commodity reading apparatus 101.

In the above-mentioned descriptions, the example that the similarity is determined in four grades with the first threshold value to the third threshold value is described as the plurality of threshold values, but the embodiment is not limited to that. The determination also can be carried out in more grades, using more than three threshold values, or the determination also can be carried out by using less than two threshold values. In addition, each threshold value also can be set to be capable of being changed by a user. In addition, in the above-mentioned description, the example that the first threshold value to the third threshold value and the conditions “a”-“c” are common for all the commodities is explained, but it is not limited to that, and each threshold value and condition also can be respectively set for each registered commodity.

In the above-mentioned descriptions also, the embodiment that the first condition is divided into two grades including one (condition “b”) that displays the confirmation screen 72 and another (condition “a”) that displays no confirmation screen 72 is explained, but the first condition is not divided into a plurality of grades. That is, if other examples are shown according to the above-mentioned example, a case that the commodity is determined but the confirmation screen 72 is not displayed even if any one of the conditions “a” and “b” is met may be adopted, or it may also be adopted that a selection in which the confirmation screen 71 is displayed or not can be set.

In the above-mentioned embodiment, the checkout system 1 consisting of the POS terminal 11 and the commodity reading apparatus 101 is applied as the store system, but it is not limited to that, and a single apparatus including functions of the POS terminal 11 and the commodity reading apparatus 101 also can be applied. As the single apparatus including functions of the POS terminal 11 and the commodity reading apparatus 101, a self-checkout apparatus (hereinafter referred to as a self-POS) which is installed and used in a store such as a supermarket and the like is listed.

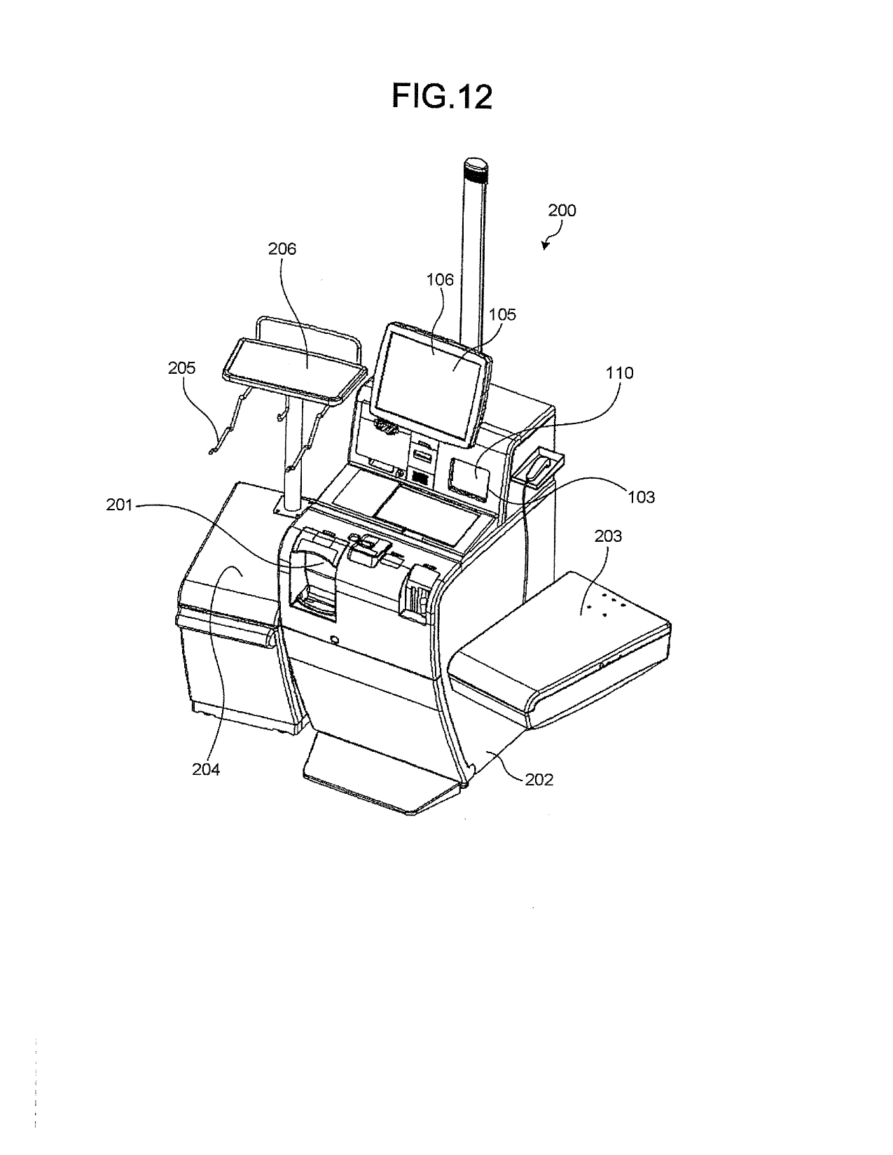

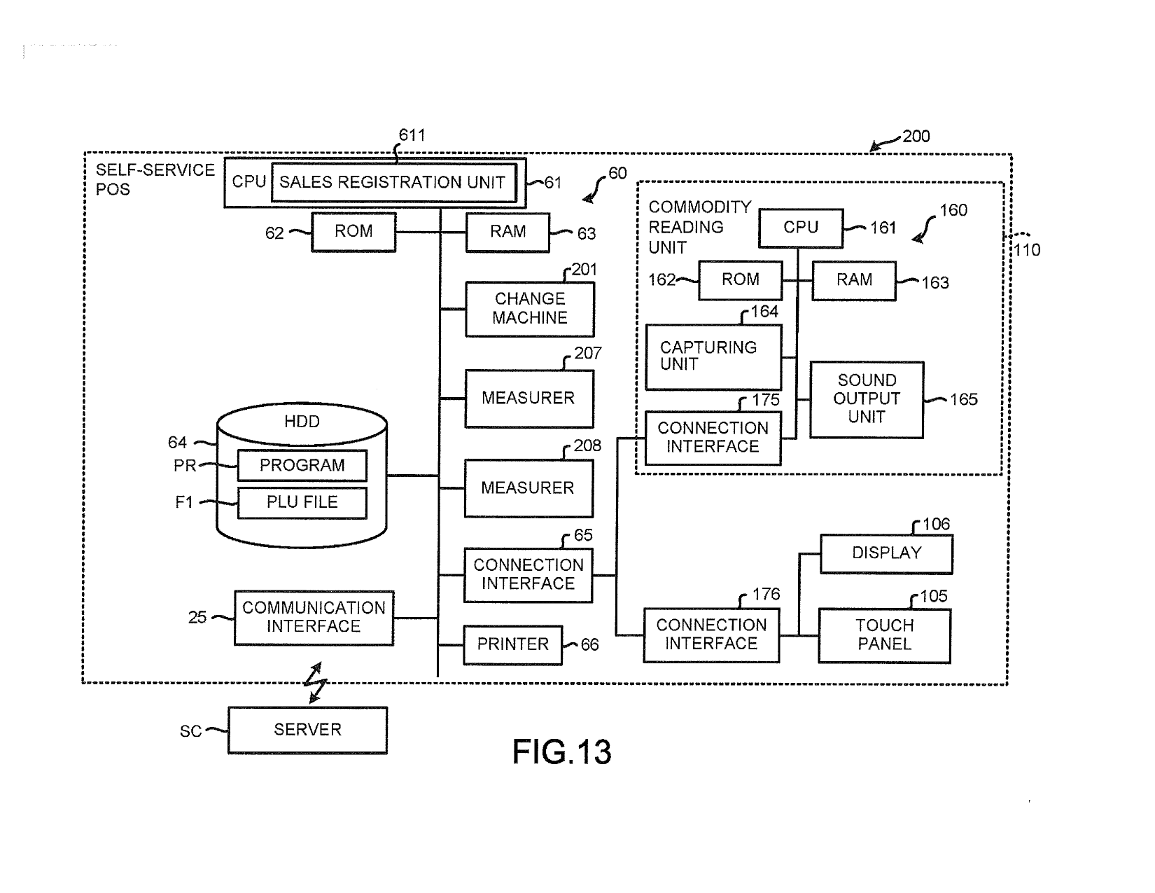

Herein, FIG. 12 is an appearance perspective view showing compositions of a self-POS 200, and FIG. 13 is a block diagram showing hardware components of the self-POS 200. In addition, hereinafter, the same compositions shown in FIG. 1 and FIG. 2 are applied with same symbols or numerals, and descriptions thereof are not repeated. As shown in FIG. 12 and FIG. 13, a main body 202 of the self-POS 200 comprises the display 106 on the surface of which the touch panel 105 is arranged, and the commodity reading unit 110 for reading the commodity image to recognize (detect) the category of the commodity and the like.

A liquid crystal display is used as the display 106, for example. The display 106 displays a guidance screen for notifying the operation method of the self-POS 200 to the customer, various input screens, a registration screen for displaying the commodity information read out by the commodity reading unit 110, and a checkout screen for displaying the total amount of the commodity, a received amount, a change amount and the selection of a payment method.

The commodity reading unit 110 reads or captures a commodity image by the image capturing unit 164 such that the customer holds the code-symbol attached to the commodity at the reading window 103 of the commodity reading unit 110.

A commodity placing counter 203 used for placing a commodity in the shopping basket whose checkout operation is not performed is arranged on the right side of the main body 202, and a commodity placing counter 204 used for placing the commodity whose checkout operation is performed, a bag hanging hook 205 used for hanging a bag into which the commodity whose checkout operation is carried out and a temporary placing counter 206 used for temporarily placing the commodity before the commodity whose checkout operation is performed is put into the bag are arranged on the left side of the main body 202. The weighing devices 207 and 208 are respectively arranged at the commodity placing counters 203 and 204, and therefore, the self-POS 200 has a function that it is confirmed by weighing devices 207 and 208 that the weight of the commodity is the same before and after the checkout operation is performed.

A change machine 201 used for keeping banknotes for checkout and for receiving banknotes changed is arranged in the main body 202 of the self-POS 200.

If the self-POS 200 with such compositions described above is applied to the store system, the self-POS 200 functions as an information processing apparatus.

The program executed by each apparatus of the above-mentioned embodiment is provided by being previously installed in a storage medium (the ROM or a storage unit) of each apparatus, but is not limited to that, and also can be provided by being stored in a computer-readable storage medium such as a CD-ROM, a floppy drive (FD), a CD-R, a DVD (Digital Versatile Disk) and the like by using a file in an installable way or an executable way. In addition, the storage medium is not limited to the computer or a medium independent from an installation system, and further includes the storage medium stored or temporarily stored by downloading the program transmitted through an LAN or an internet and the like.

The program executed by each apparatus of the above-mentioned embodiment also can be stored in the computer connected with a network such as the internet and the like, is provided by being downloaded by a network path, and also can be provided or allocated by the network path such as the internet and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
an image capturing unit configured to capture a commodity to output the image of the commodity;
an image acquisition unit configured to acquire the image outputted by the image capturing unit;
a similarity calculation unit configured to calculate a similarity showing the degree of similarity between the image of the commodity captured by the image capturing unit and the reference image of each registered commodity, which is registered together with a superior category showing information relevant with each registered commodity in a dictionary;
a determination unit configured to compare the degree of similarity between the reference image and each image acquired by the image acquisition unit and determine whether or not the degree of similarity of the superior category obtained by adding the similarities of a plurality of varieties belonging to the same superior category meets a specified condition; and
a reporting unit configured to report the information relevant with a commodity corresponding to the plurality of varieties meeting the specified condition as a candidate of the captured commodity if the determination unit determines that the specified condition is met.

2. The information processing apparatus according to claim 1, wherein
the determination unit compares the degree of similarity between the reference image and each image acquired by the acquisition unit and determines whether or not the degree of similarity meets a first condition for determining the captured commodity as a commodity corresponding to the reference image; and
the reporting unit reports that the captured commodity is determined as the commodity meeting the first condition and corresponding to the reference image if the determination unit determines that the first condition is met.

3. The information processing apparatus according to claim 1, wherein
the reporting unit displays, as a candidate commodity, the information relevant with the registered commodity which meets the specified condition and is a different variety belonging to the same superior category on a display unit.

4. The information processing apparatus according to claim 3, wherein
the reporting unit displays the information relevant with the registered commodity as a candidate commodity in a descending order of the degree of similarity.

5. The information processing apparatus according to claim 3, wherein
the reporting unit displays the information relevant with the registered commodity as a candidate commodity in a descending order of the number of selections.

6. A store system, comprising:
An image capturing unit configured to capture a commodity to output the image of the commodity;
an image acquisition unit configured to acquire the image outputted by the image capturing unit;
a similarity calculation unit configured to calculate a similarity showing the degree of similarity between the image of the commodity captured by the image capturing unit and the reference image of each registered commodity, which is registered together with a superior category showing information relevant with each registered commodity in a dictionary;
a determination unit configured to compare the degree of similarity between the reference image and each image acquired by the image acquisition unit and determine whether or not the degree of similarity of the superior category obtained by adding the similarities of a plurality of varieties belonging to the same superior category meets a specified condition;
a reporting unit configured to report the information relevant with a commodity corresponding to the plurality of varieties meeting the specified condition as a candidate of the captured commodity if the determination unit determines that the specified condition is met
a reception unit configured to receive an operation for determining the candidate of the commodity as the commodity captured by the image capturing unit if the operation to select at least one commodity in the candidates of the commodity is carried out; and
a sales registration processing unit configured to carry out sales registration processing on the commodity, captured by the image capturing unit, which is determined by the determination unit or the reception unit as a determined commodity.

7. A method, comprising:
capturing a commodity to output the image of the commodity;
acquiring the outputted image;
calculating a similarity showing the degree of similarity between the image of the captured commodity and the reference image of each registered commodity, which is registered together with a superior category showing information relevant with each registered commodity in a dictionary;
comparing the degree of similarity between the reference image and each acquired image and determining whether or not the degree of similarity of the superior category obtained by adding the similarities of a plurality of varieties belonging to the same superior category meets a specified condition; and
reporting the information relevant with a commodity corresponding to the plurality of varieties meeting the specified condition as a candidate of the captured commodity if the specified condition is met.
